(19) United States
(12) Patent Application Publication
(10) Pub. No.: US 2023/0032961 A1
(43) Pub. Date: Feb. 2, 2023

(54) SYSTEMS AND METHODS FOR CONFIGURING AND OBTAINING INDUSTRIAL EQUIPMENT

(71) Applicant: EXPEDI, INC., Houston, TX (US)

(72) Inventors: Jonathan Hamilton, Houston, TX (US); Jonathon Howey, Houston, TX (US); Andrew McLeroy, Houston, TX (US); Rory Magdaleno, Houston, TX (US)

(21) Appl. No.: 17/876,152

(22) Filed: Jul. 28, 2022

Related U.S. Application Data
(60) Provisional application No. 63/226,728, filed on Jul. 28, 2021.

(51) Int. Cl. G06Q 30/06

(52) U.S. Cl. CPC G06Q 30/0621; G06Q 30/0627; G06Q 30/0643

(57) ABSTRACT

Systems and methods for specifying and obtaining a piece of industrial equipment make use of a configurator software application that allows a user to input and/or select various items of information that define the piece of industrial equipment. As the user enters/selects items of information, a display of the piece of industrial equipment can be updated and presented to the user to allow the user to confirm the configuration. The user can manipulate the displayed image in various ways to confirm the configuration. The configurator software application can also provide a convenient way for the user to order the specified piece of industrial equipment or send a quote for construction of the specified piece of industrial equipment to one or more vendors.

This application claims priority to the Jul. 28, 2021 filing date of U.S. Provisional Application No. 63/226,728, the contents of which are incorporated herein by reference.

### BACKGROUND

The disclosed systems and methods relate to ways in which industrial equipment can be configured and ordered via a computer-based process.

### BRIEF DESCRIPTION OF THE DRAWINGS

FIG. 1 illustrates a computer-based environment in which the disclosed systems and methods can be practiced;

FIG. 2 is a diagram of a configurator according to the disclosed systems and methods;

FIG. 3 is a diagram illustrating steps of a method for configuring and obtaining an item of industrial equipment; and

FIG. 4 is a block diagram of a computer system which can be used to perform the disclosed methods.

### DETAILED DESCRIPTION

In the disclosed methods, a user accesses a configuration software application that allows the user to input or select various items of information that define or describe characteristics of a piece of industrial equipment. During this process, the software application causes of three-dimensional model of the piece of industrial equipment to be displayed to the user. As the user provides additional items of information defining characteristics of the piece of industrial equipment, the displayed model can be updated so that the model always accurately reflects all of the items of information provided by the user. The user may be provided with the ability to manipulate the displayed three-dimensional model, such as by rotating the displayed model, enlarging all or a portion of the model, converting the displayed model from an assembled view to an exploded view, or in other helpful ways. This allows the user to visually confirm that the items of information the user is providing will result in a piece of industrial equipment that includes those characteristics desired by the user.

Once a sufficient number of items of information describing the piece of industrial equipment have been established, the software application checks to determine if there are one or more vendors or manufacturers that offer a piece of industrial equipment as specified by the user. If so, the software application can present the user with purchase options, and also facilitate the ordering of one of the vendor-offered pieces of industrial equipment. If no versions of the piece of industrial equipment are commercially available, the software application may facilitate a process in which a request for quote for the specified piece of industrial equipment is sent to one or more vendors or manufacturers. Also, once the user has input/selected items of information describing the piece of industrial equipment, the software application may allow the user to save the configuration of the piece of industrial equipment in a database for later use.

The following description focuses on configuring and ordering one or more valves. However, valves are just one example of an item of industrial equipment that could be selected and ordered using the systems and methods disclosed herein. The systems and methods disclosed herein could also be used to configure and order any other item of industrial equipment. Thus, the focus on valves for purposes of explaining the systems and methods should in no way be considered limiting.

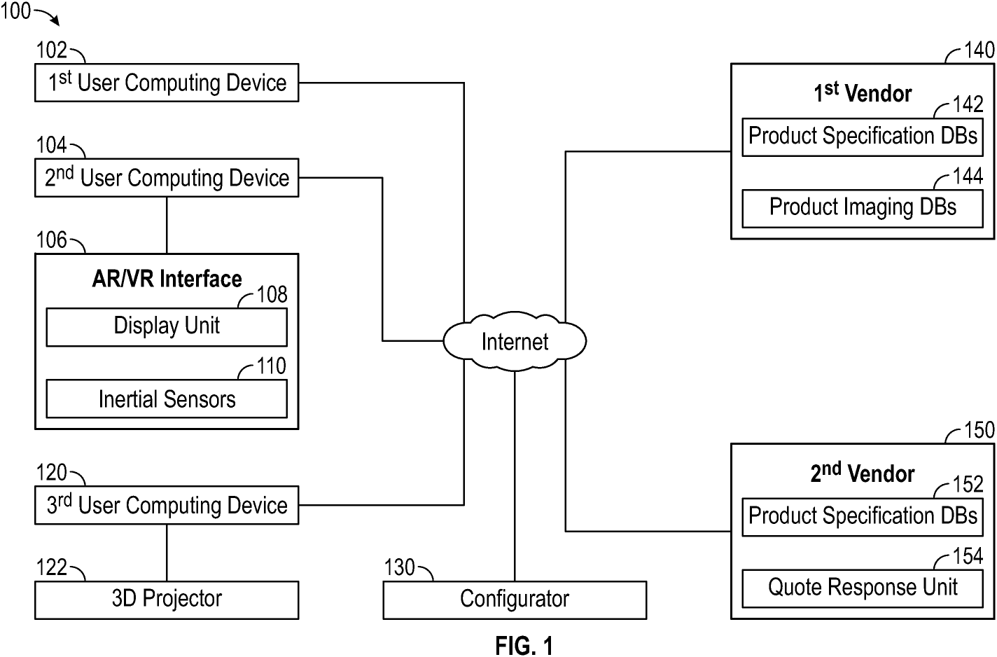

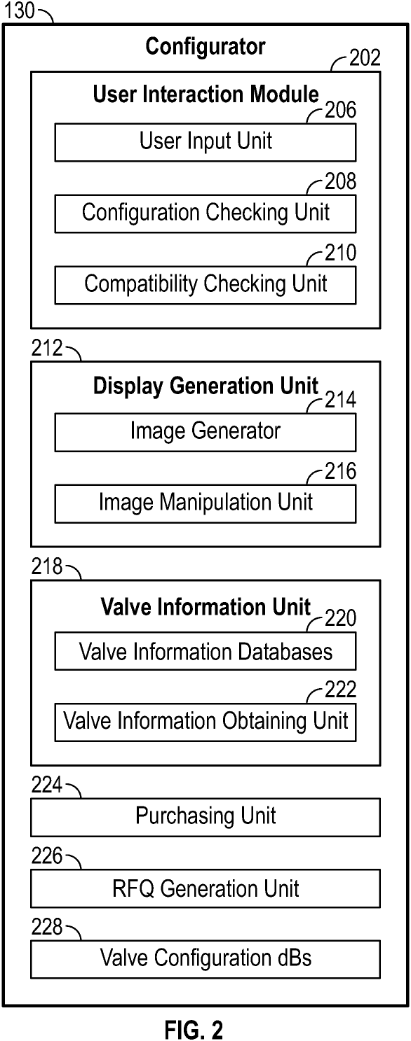

FIG. 1 illustrates an environment in which the disclosed systems and methods can be practiced. In this environment, users can operate first, second and third user computing devices 102, 104, 120 to access a configurator 130 via a computer network 110, such as the Internet. The user computing devices 102, 104, 120 could be a desktop computer, a laptop computer, a tablet computer, a smartphone or any other computing device that allows the user to access the configurator 130 via a computer network such as the Internet 110. Details of the configurator 130 are discussed below in connection with FIG. 2.

The second user computing device 104 is coupled to an augmented reality (AR)/virtual reality (VR) interface 106, which the user could operate to help with the configuration and ordering process. For example, a user could operate the AR/VR interface 106 to manipulate a displayed two-dimensional or three-dimensional image of a piece of industrial equipment that the user is configuring and ordering. The AR/VR interface 106 could thus be used to help the user visualize the piece of equipment being configured and also to place an order for the piece of equipment once it is configured. Also, the AR/VR interface 106 might be used to help a user visualize or verify that two or more pieces of equipment can be connected or integrated with one another.

The AR/VR interface 106 includes a display unit 108 that presents the user with a field of view. The display unit 108 could be, for example, a virtual reality headset with an integrated display that fills substantially all of the user’s visual field. Alternatively, the display unit 108 could take the form of glasses that project images into the user’s field of view to provide an augmented reality view.

The AR/VR interface 106 could also include inertial sensors 110 that are designed to generate signals that help a user navigate through menu selections or to take certain actions in a virtual reality or augmented reality space. The inertial sensors 110 could take the form of hand-held devices or gloves that include both inertial sensing devices and user selectable buttons or switches. The inertial sensors 110 and any associated buttons and switches could be operated by the user to manipulate a displayed image or model of a piece of equipment that is being configured, to make menu selections, to enter information and to take other actions.

The third computing device 120 is coupled to a three-dimensional projector 122. The three-dimensional projector could be, for example, a holographic projector capable of rendering images in three dimensions. Such a three-dimensional projector 122 could be used to display a three-dimensional image of a piece of equipment that is being configured. The three-dimensional projector 122 could also be used to illustrate and verify how two or more pieces of equipment are to be connected to or integrated with one another.

Also present in this environment are first and second vendors 140, 150. The vendors could manufacture, sell and/or resell pieces of industrial equipment. The first vendor 140 maintains product specification databases 142 that the first vendor 140 may or may not make available to the public. The first vendor 140 also maintains product imaging databases 144 that contain two-dimensional and/or three-dimensional model data for products manufactured and/or sold by the first vendor 140. The first vendor 140 may make such imaging information available to its clients and customers.

The second vendor 150 also maintains product specification databases 152 with information on the pieces of equipment manufactured and/or sold by the second vendor 150. The second vendor also provides a quote response unit 154 which responds to client or customer requests for a quote to provide a piece of industrial equipment that is not commonly offered by the vendor 150. This would occur when the client or customer requires a piece of equipment that is non-standard or that is not typically held in inventory. When a request for a quote to provide such a piece of equipment is received by the quote response unit 154, the quote response unit 154 generates a quote for providing the requested item and sends the quote back to the requesting customer. The quote could include a price, a delivery schedule, details about the piece of equipment that the second vendor 150 is capable of providing, shipping information and other information relevant to the manufacture and delivery of the requested item.

FIG. 2 illustrates selected elements of a configurator 130 that can operate to configure and possibly place an order to purchase a piece of industrial equipment. The configurator 130 could be implemented as one or multiple software applications running on one or more servers accessible via a computer network such as the Internet 110. In this instance, a user operating a user computing device like user computing devices 102, 104 and 120 illustrated in FIG. 1 could access the configurator 130 via a data network. Alternatively, the configurator 130 could be implemented as one or multiple software applications that are running on one of the user computing devices 102, 104, 120. In still other embodiments, the functions provided by the configurator 130 could be provided by one or more software applications running on a server and one or more software applications running on a user computing device 102, 104, 120. Thus, the configurator 130 could be implemented via multiple software applications that are split between one or more servers and one or more user computing devices 102, 104, 120.

The configurator 130 includes a user interaction module 202 that is designed to allow a user to input or select various items of information that describe or define one or more items of industrial equipment. The user interaction module 202 includes a user input unit 206 that allows a user to input items of information and/or select items of information from menus, the items of information describing characteristics of a valve (or any other item of industrial equipment) in various ways. The user input unit 206 could present the user with a series of menus or drop-down displays that allow the user to select items of information describing characteristics of the valve from pre-determined options. Alternatively, the user input unit 206 could allow a user to input items of information using pre-determined keywords or phrases. In still other embodiments, the user input unit 206 could be configured to allow a user to input natural-language descriptions which the user input unit 206 then parses and interprets. User input in the form of keywords or phrases or in the form of natural-language input could be provided using a keyboard or via voice input.

The user input unit 206 is configured so that a user can operate the typical elements of a user computing device 102, 104, 120, such as a keyboard, a display screen and one or more pointing devices in order to select or input items of information regarding a valve. Alternatively, or in addition, the user input unit 206 could be configured to allow a user to operate elements of an AR/VR interface 106 coupled to a user computing device 104 to input items of information regarding a valve.

For example, the user could simply utilize a keyboard or a speech-to-text function to input “½ inch on/off valve that is electrically operated.” The user input unit 206 could then use this input to determine that the user is attempting to acquire an on/off valve to be used with ½ inch piping and that is to be electrically operated, as opposed to manually or pneumatically operated. With this to start from, the user input unit 206 could then present the user with additional menus or input mechanisms that allow the user to further define characteristics of the valve in accordance with any additional features that would typically be included with that type of on/off valve.

If the user is provided with menus to select items of information describing a valve, the menus would typically only include options that make sense or that are physically feasible. If the user is able to input items of information describing a valve that are not based on pre-determined menu options, a configuration checking unit 208 and/or a compatibility checking unit 210 may act to check each item of information provided by the user as it is input to determine if the input item of information makes sense and/or is physically feasible. For example, if the user input unit 206 receives an item of information that does not come from a menu selection, the configuration checking unit 208 could perform a check to determine if the newly provided item of information would be possible, given all the other information that has already been received from the user. In other words, would it be physically possible for a valve that satisfies all previously entered items of input information to also satisfy the latest item of information provided by the user.

The configuration checking unit 208 can consult one or more databases of valve information 220 to help determine whether items of information selected or input by a user make sense or are physically feasible. The information in the valve information databases 220 could include information about commercially available valves. However, the valve information databases 220 may also include proprietary information about the compatibility of various device features. Alternatively, or in addition, the configuration checking unit 208 could consult product specification databases 142/152 that are made available by valve vendors 140/150 for this purpose.

Similarly, if the valve is to be used in a particular known application, or if the valve is to interface with known items of other equipment, when the user input unit 206 receives a new item of information that does not come from a menu selection, the compatibility checking unit 210 could perform a check to determine if the newly provided item of information would result in a valve that could be installed in the known application or that is compatible with the other items of equipment with which it must interface.

If a check performed by either the configuration checking unit 208 or compatibility checking unit 210 indicates that the new item of information would result in a valve that is not physically feasible or that will not work in the application where it is to be installed, then the user input unit 206 rejects the new item of information and so informs the user. The way in which this is accomplished could vary. But the point is that the user interaction module will not allow a user to specify a combination of features for a valve which are known to be impossible or which will not work for the application in which the valve is to be used. The user then has an opportunity to provide an alternate item of information for the valve configuration that is more likely to work.

As the user selects or inputs items of information describing a valve, a display generation unit 212 causes an image of the valve to be displayed to the user on a display screen. The display screen could be a typical display associated with a user computing device. Alternatively, the image of the valve could be displayed to a user via an AR/VR interface 106 coupled to a user computing device 104 or such an image could be presented to a user via a three-dimensional projector 122 coupled to a user computing device 120. The image of the valve could be presented as one or more two-dimensional drawings or diagrams and/or cross-sectional views. Alternatively, and preferably, the image is presented as one or more three-dimensional views or cross-sectional views.

The image of the valve that is presented to the user is generated by the image generator 214 of the display generation unit 212. The image generator 214 could obtain two-dimensional and/or three-dimensional image data from databases maintained by the configurator, such as the valve information databases 220. Alternatively, or in addition, the image generator 214 could obtain two-dimensional and/or three-dimensional image data from one or more vendors. For example, the image generator 214 could obtain image data for a valve from one or more product imaging databases 144 maintained by a vendor 140.

As new items of information are received from the user by the user input unit 206, the image generator 214 updates the image displayed to the user to reflect the newly input information.

For example, if the user first specifies a simple on/off valve that is to be manually operated, the image generator 214 will cause a basic image of such a manually operated on/off valve to be displayed to the user. If the user then specifies that the valve is to be used on ½" piping and that the flanges are to be bolted into adjacent piping, the image generator 214 causes the image being presented to the user to be updated to show appropriate sizes for a ½" valve and to include flanges for bolting to adjacent piping. If the user then specifies that each flange is to include four bolt holes, the image generator 214 updates the image of the valve so that the flanges each include four bolt holes. In this way, the image generated by the image generator 214 and displayed to the user is updated as the user provides new items of information that affect how the valve appears.

In some embodiments, the display generation unit 212 includes an image manipulation unit 216 that provides the user with the ability to manipulate the image generated by the image generator 214 and that is being displayed to the user. For example, the image manipulation unit 216 can allow a user to rotate a three-dimensional image of a valve so that the user can see the sides, the top and the bottom of the valve. The image manipulation unit 216 may also enable a user to enlarge or contract all or a portion of the displayed image so that the user can obtain a more detailed view of portions of the valve. Also, the image manipulation unit 216 may enable a user to switch from an assembled view to an exploded view, or vice versa.

To accomplish manipulation of the displayed image, the image manipulation unit 216 could receive signals from a pointing device and a keypad of a user computing device. Alternatively, or in addition, the image manipulation unit 216 could receive signals from an AR/VR interface 106 coupled to a user computing device 104. For example, the image manipulation unit 216 could receive signals from one or more inertial sensors 110 of the AR/VR interface 106. Those signals could be interpreted as requests to manipulate the displayed image in various ways.

Further, in some instances, the user may be able to view an animation of the specified valve in action or view an animation of the valve being exploded into its component parts or contracted into an assembled version. All such depictions are provided to the user to help the user verify that the items of information the user has selected or input accurately describe the valve that the user wishes to acquire.

The display generation unit 212 could also generate tables, graphs, charts and other depictions of information about a valve as the user inputs/selects items of information describing the valve. Such tables, graphs, charts and other depictions could be updated as the user inputs/selects additional items of information describing a valve.

The configurator 130 also includes a valve information unit 218 that obtains and stores information about various valves that are commercially available. The valve information unit 218 includes one or more valve information databases 220 in which such valve information is stored. A valve information obtaining unit 222 obtains information about available valves and stores that information in the valve information databases 220. The valve information obtaining unit 222 obtains information about valves from product specification databases 142, 152 maintained by vendors 140, 150, as well as from other public and private data sources.

Keeping information about valves in readily available localized valve information databases 220 makes it possible for the configuration checking unit 208 and the compatibility checking unit 210 to perform quick checks on user provided information when a user is attempting to specify the configuration for a valve. This eliminates the potentially time-consuming process that otherwise would be required to search for such information in remote third-party databases.

The valve information obtaining unit can be configured to periodically obtain information about valves and other items of industrial equipment from vendors, manufacturers and other sources, and then index and store that obtained information in a way that makes it possible to rapidly check items of information input or selected by a user. This allows the user interaction module 202 to avoid accepting user input/selected items of information that are not likely to work during the specification process.

Similarly, the display generation unit 212 may obtain imaging information from the valve information databases 220. For this reason, the valve information obtaining unit 222 may seek out and obtain valve imaging information in addition to valve configuration information and store such valve imaging information in the valve information databases 220.

Once a user has selected or input a sufficient number of items describing or defining a valve, a purchasing unit 224 consults the valve information databases 220 or the purchasing unit 224 interacts with vendors 140, 150 to determine whether the valve specified by the user is commercially available. If the user specified valve is commercially available, the purchasing unit 224 can provide the user with information about the commercially available valve or valves. If more than one vendor can provide a valve that satisfies the user-specified configuration, then the purchasing unit 224 could present information about each of the valves offered by those vendors. Such information could include pricing details, vendor inventory levels and a projected lead time for delivery of such a valve. Such information could also include specification sheets and/or photographs and/or diagrams of the valves offered by each vendor that satisfy the user-defined items of information. Where multiple vendors offer the user-specified valve, such information could allow the user to select one of the valves for purchase.

The purchasing unit 224 could also enable the user to purchase a valve provided by a particular vendor by allowing the user to add the specified valve to an online shopping cart that is being maintained for the user. The user could then proceed to an online checkout process in which the user provides payment details. Alternatively, the user could then proceed to specify one or more additional valves (or other pieces of equipment) that the user wishes to acquire before proceeding to a checkout procedure.

If the user specified valve is not commercially available, a Request For Quote (RFQ) generation unit 226 of the configurator 130 is able to generate a request for a quote that can be submitted to one or more vendors asking the vendors for a quote to provide the specified valve. The request could ask for the cost and perhaps a delivery timeline for obtaining or constructing the specified valve. The RFQ generation unit 226 could then transmit the request for quote to one or more vendors.

If the RFQ generation unit 226 thereafter obtains a quote from a vendor, the RFQ generation unit 226 passes details of the quote back to the user who specified the valve. If the user wishes to accept a quote provided by a vendor, the RFQ generation unit 226 coordinates with the purchasing unit 224 to place an order for the valve with the vendor.

Once a user has selected or input all the items of information that define a valve, the configurator 130 provides the user with the opportunity to save the valve configuration in one or more valve configuration databases 228. The valve configuration could be saved against the user’s identity or the identity of a company for whom the user works. Various details about the purpose or location or environment in which the valve will be used could be stored in the valve configuration databases 228 along with the valve configuration details.

The configurator 130 may also provide the user with a mechanism for communicating details about a configured valve to other individuals. For example, the user interaction module 202 could allow a user to send an email to a coworker or other individual that includes information about a valve configuration that the user has created with the user interaction module 202.

The information stored in the valve configuration databases 228 could have commercial significance to entities other than the users who specified the configurations of the valves. For example, information in the valve configuration databases 228 could be indexed, collated or organized to determine the needs of a particular customer or the needs of individual industrial locations maintained by a customer. This could include information about what valves a particular customer has recently purchased, and where those valves were to be installed. Such information could then be provided to vendors or manufacturers who can use such information to market to the customer and also to determine what future needs are likely to arise. Indeed, such information could be sold to valve vendors and manufacturers to help them market to customers and determine how and where to stock inventory.

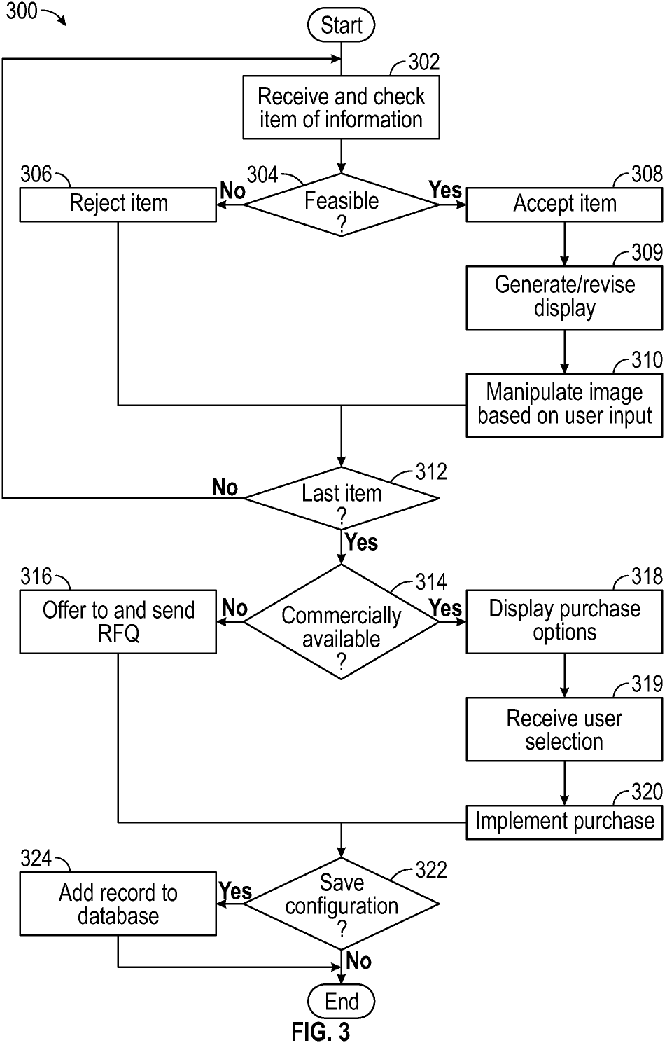

FIG. 3 illustrates steps of a method 300 for specifying the configuration of a valve, purchasing a specified valve, sending off a request for a quote to provide the specified valve and possibly also storing information about the valve configuration in a configuration database. The steps of the method 300 are described below with reference to FIG. 3.

The method 300 begins and proceeds to step 302 in which a user interacts with a user interaction module 202 of a configurator 130 to select or input an item of information defining or describing a valve. The method proceeds to step 304 where a configuration checking unit 208 and/or a compatibility checking unit 210 check the item of information to make sure that it makes sense and would be physically feasible. This step can be performed by consulting information in valve information databases 220, and possibly also by consulting information in valve databases 142/152 made available by valve vendors or manufacturers.

If the check performed in step 304 indicates the selected/input item of information does not make sense or is not physically feasible, the method proceeds to step 306 where the configurator 130 informs the user that the selected or input item of information does not make sense or is physically impossible. This could be done by presenting the user with a message to take effect. And if a message is provided, the message could include guidance about why the input item of information has been rejected. In some instances, rejection of an input item may take the form of simply making it impossible for the user to complete the input process.

In embodiments where the user is selecting items of information based on pre-defined menus, only sensible and physically possible items of information would be presented to the user as selectable menu items. Thus, check(s) performed in step 304 and any corresponding rejection step 306 may not be required.

If the selected/input item of information is acceptable, the method proceeds to step 308, where the item of information is accepted. The method then proceeds to step 309 where a display generation unit 212 generates and/or updates a display of the valve to reflect the accepted item of information. Of course in some instances, the newly accepted item of information may not result in a change to the appearance of the valve, in which case no changes to the displayed image will occur.

In optional step 310, an image manipulation unit 216 receives an indication from the user that the user wishes to change or modify the display of the valve. In that instance, the image manipulation unit 216 causes the image generator 214 to modify the image of the valve being displayed to the user based on the user’s indicated preferences.

The method then proceeds to step 312 where the configurator 130 checks to determine if all items of information defining a valve have been input. If not, the method loops back to step 302 for input/selection of the next item of information. If all required items of information have been input/selected, the method proceeds to step 314.

In step 314, a purchasing unit 224 of the configurator 130 consults one or more databases of valve information 220 or possibly valve databases 142/152 provided by vendors 140/150 to determine whether the user-specified valve is available from any vendors. If so, the method proceeds to step 318 where the purchasing unit 224 displays to the user information about commercially available valves that satisfy the user’s specifications. This could include presenting information for two or more valves that are available which satisfy the user-specified requirements. As noted above, the information could include dimensions, pricing, vendor inventory levels, lead times to delivery, as well as other items of information.

If step 318 involved displaying information about multiple commercially available valves, in step 319 the purchasing unit 224 receives a selection of one of the valves from the user. The method then proceeds to step 320 where the purchasing unit 224 enables the user to purchase the selected valve.

If the check performed in step 314 indicates that the user-specified valve is not commercially available, the method proceeds to step 316 and a RFQ generation unit 226 of the configurator 130 allows the user to generate a request for a quote to provide the user-specified valve. The RFQ generation unit 226 could thereafter submit such a quote request to one or more vendors.

The method then proceeds to step 322, where the configurator 130 offers to save details about the user-specified valve in a valve configuration database 228 of the configurator 130. If the user does wish to save information about the user-specified valve, the method proceeds to step 324 and a new record with details about the valve is created and stored in the valve configuration database 228. Thereafter, the method ends.

The above descriptions indicate how systems and methods according to the disclosure can be used to input or select items of information for a single valve or a single piece of industrial equipment, and then purchase the specified item. In alternate embodiments, the user could select or input items of information about multiple valves or multiple pieces of industrial equipment at the same time. For example, the user could input/select items of information describing two valves or two pieces of industrial equipment that may or may not be designed to work together. Thus, the disclosure is not limited to specifying information for only a single item of industrial equipment at one time.

In alternate embodiments where the user is inputting or selecting items of information for two or more pieces of industrial equipment at the same time, the compatibility of the two items can be taken into account by the compatibility checking unit 210 before the user input unit 206 presents the user with menu choices or when determining whether a user submitted item of information for one or both of the two items of industrial equipment makes sense. If a user-submitted item of information for a first of two pieces of industrial equipment would result in the first piece of industrial equipment being incompatible with the second piece of industrial equipment, the user-submitted item of information could be rejected.

Similarly, when the user is inputting or selecting items of information for two pieces of industrial equipment, the depictions or displays presented to the user would be updated as items of information are input/selected. The depictions provided to the user may help the user to determine if the two items are compatible with one another.

Once the user has inputted all required items of information for multiple pieces of industrial equipment, a check could be performed to determine if either or both of the pieces of industrial equipment are commercially available. If so, the user could be provided with the opportunity to add both specified pieces of industrial equipment to a shopping cart. If one or both of the specified pieces of industrial equipment are not available, the user could be provided with an opportunity to have requests for bids submitted to vendors or manufacturers in keeping with the methods described above.

The disclosed systems and methods may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as JavaⓇ, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

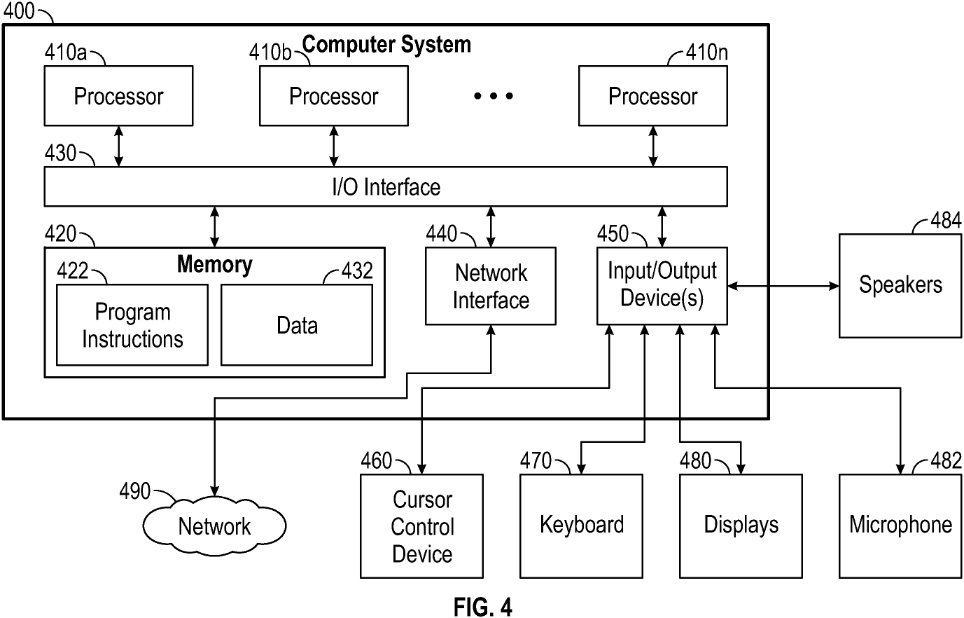

FIG. 4 depicts a computer system 400 that can be utilized in various embodiments of the present invention to implement the invention according to one or more embodiments. The various embodiments as described herein may be executed on one or more computer systems, which may interact with various other devices. One such computer system is the computer system 400 illustrated in FIG. 4. The computer system 400 may be configured to implement the methods described above. The computer system 400 may be used to implement any other system, device, element, functionality or method of the above-described embodiments. In the illustrated embodiments, the computer system 400 may be configured to implement the disclosed methods as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, an input/output devices interface 450. The input/output devices interface 450 facilitates connection of external I/O devices to the system 400, such as cursor control device 460, keyboard 470, display(s) 480, microphone 482 and speakers 484. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, the computer system 400 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices interface 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

External input/output devices interface 450 may, in some embodiments, include one or more display terminals, keyboards, keypads, touchpads, scanning devices, voice or optical recognition devices, or any other devices suitable for entering or accessing data by one or more computer systems 400. Multiple input/output devices may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the operations and methods described above, such as the methods illustrated by the flowcharts of FIGS. 2 and 3. In other embodiments, different elements and data may be included.

Those skilled in the art will appreciate that the computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In many of the foregoing descriptions, a software application running on a computing device may perform certain functions related to the disclosed technology. In alternate embodiments, a browser running on a computing device may access a software application that is running on some other device via a data network connection. For example, the software application could be running on a remote server that is accessible via a data network connection. The software application running elsewhere, and accessible via a browser on the computing device may provide all of the same functionality as an application running on the computing device itself. Thus, any references in the foregoing description and the following claims to an application running on a computing device are intended to also encompass embodiments and implementations where a browser running on a computing device accesses a software application running elsewhere via a data network.

Also, a computing device embodying the disclosed technology or which is configured to perform methods embodying the disclosed technology can make use of a typical user interface that includes a keyboard, a display screen and one or more pointing devices. Alternatively, or in addition, a computing device embodying the disclosed technology or which is configured to perform methods embodying the disclosed technology can make use of an augmented reality interface or a virtual reality interface. Further, computing devices embodying the disclosed technology or which are configured to perform methods embodying the disclosed technology can make use of artificial intelligence to enable some or all aspects of the disclosed technology.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of configuring and ordering a piece of industrial equipment, comprising:
receiving from a user multiple items of information that define characteristics of a piece of industrial equipment;
causing a three-dimensional model of the piece of industrial equipment to be displayed to the user, wherein the three-dimensional model is updated to reflect new items of information received from the user;
determining whether a piece of industrial equipment having the characteristics defined by the items of information received from the user is commercially available; and
offering to add the piece of industrial equipment to an electronic shopping cart when a piece of industrial equipment having the characteristics defined by the items of information received from the user is commercially available.

2. The method of claim 1, further comprising:
receiving from the user an indication that the user wishes to modify how the three-dimensional model of the piece of industrial equipment is displayed; and
causing the three-dimensional model of the piece of industrial equipment to be displayed in accordance with the indication received from the user.

3. The method of claim 2, wherein the indication received from the user indicates that the user wishes to enlarge at least a portion of the three-dimensional model.

4. The method of claim 2, wherein the indication received from the user indicates that the user wishes to rotate the displayed three-dimensional model.

5. The method of claim 2, wherein the indication received from the user indicates that the user wishes to view an exploded view of the piece of industrial equipment.

6. The method of claim 1, further comprising:
generating a request for quotation for a piece of industrial equipment having the characteristics defined by the items of information received from the user when a piece of industrial equipment having the characteristics defined by the items of information received from the user is not commercially available; and
submitting the request for quotation to at least one vendor or manufacturer.

7. The method of claim 1, further comprising saving at least one record for the piece of industrial equipment in a configuration database, the at least one record including information about the characteristics defined by the items of information received from the user.

8. The method of claim 7, wherein the at least one record that is saved in the configuration database is tied in some fashion to the user that provided the multiple items of information.

9. The method of claim 1, wherein the receiving step comprises:
displaying to the user at least one menu that has multiple options for at least one characteristic that defines the piece of industrial equipment; and
receiving from the user a selection from the displayed menu.

10. The method of claim 1, wherein the receiving step comprises:
checking at least one item of information received from the user to determine whether the at least one item of information would result in a piece of industrial equipment that is reasonably feasible to manufacture;
accepting the at least one item of information when the at least one item of information would result in a piece of industrial equipment that is reasonably feasible to manufacture; and
rejecting the at least one item of information when the at least one item of information would not result in a piece of industrial equipment that is reasonably feasible to manufacture.

11. The method of claim 1, wherein the receiving step comprises:
checking at least one item of information received from the user to determine whether the at least one item of information would result in a piece of industrial equipment that is compatible with at least one other item of industrial equipment;
accepting the at least one item of information when the at least one item of information would result in a piece of industrial equipment that is compatible with the at least one other item of industrial equipment; and
rejecting the at least one item of information when the at least one item of information would not result in a piece of industrial equipment that is compatible with the at least one other item of industrial equipment.

12. The method of claim 1, wherein the receiving step comprises receiving multiple items of information that define characteristics of a first piece of industrial equipment, the method further comprising:
receiving from the user multiple items of information that define characteristics of a second piece of industrial equipment
checking at least one of the items of information received from the user for either the first or the second piece of equipment to determine whether the at least one item of information would result in the first and second pieces of industrial equipment being compatible with one another;
accepting the at least one item of information when the at least one item of information would result in the first and second pieces of industrial equipment being compatible with one another; and
rejecting the at least one item of information when the at least one item of information would not result in the first and second pieces of industrial equipment being compatible with one another.

13. The method of claim 1, wherein when the result of the determining step indicates that multiple vendors offer a piece of industrial equipment having the characteristics defined by the items of information received from the user, the offering step comprises displaying information from each of the vendors that offer a piece of industrial equipment having the characteristics defined by the items of information received from the user.

14. A non-transitory computer-readable medium storing instructions that, when performed by one or more processors of one or more computing devices, cause the one or more processors to perform a method of configuring and ordering a piece of industrial equipment, the method comprising:
receiving from a user multiple items of information that define characteristics of a piece of industrial equipment;
causing a three-dimensional model of the piece of industrial equipment to be displayed to the user, wherein the three-dimensional model is updated to reflect new items of information received from the user;
determining whether a piece of industrial equipment having the characteristics defined by the items of information received from the user is commercially available; and
offering to add the piece of industrial equipment to an electronic shopping cart when a piece of industrial equipment having the characteristics defined by the items of information received from the user is commercially available.

15. The non-transitory computer-readable medium of claim 14, wherein the method performed by the one or more processors further comprises:
receiving from the user an indication that the user wishes to modify how the three-dimensional model of the piece of industrial equipment is displayed; and
causing the three-dimensional model of the piece of industrial equipment to be displayed in accordance with the indication received from the user.

16. The non-transitory computer-readable medium of claim 15, wherein the indication received from the user indicates that the user wishes to enlarge at least a portion of the three-dimensional model.

17. The non-transitory computer-readable medium of claim 15, wherein the indication received from the user indicates that the user wishes to rotate the displayed three-dimensional model.

18. The non-transitory computer-readable medium of claim 15, wherein the indication received from the user indicates that the user wishes to view an exploded view of the piece of industrial equipment.

19. The non-transitory computer-readable medium of claim 14, wherein the method performed by the one or more processors further comprises:
generating a request for quotation for a piece of industrial equipment having the characteristics defined by the items of information received from the user when a piece of industrial equipment having the characteristics defined by the items of information received from the user is not commercially available; and
submitting the request for quotation to at least one vendor or manufacturer.

20. The non-transitory computer-readable medium of claim 14, wherein the method performed by the one or more processors further comprises saving at least one record for the piece of industrial equipment in a configuration database, the at least one record including information about the characteristics defined by the items of information received from the user.

21. The non-transitory computer-readable medium of claim 20, wherein the at least one record that is saved in the configuration database is tied in some fashion to the user that provided the multiple items of information.

22. The non-transitory computer-readable medium of claim 14, wherein the receiving step comprises:
displaying to the user at least one menu that has multiple options for at least one characteristic that defines the piece of industrial equipment; and
receiving from the user a selection from the displayed menu.

23. The non-transitory computer-readable medium of claim 14, wherein the receiving step comprises:
checking at least one item of information received from the user to determine whether the at least one item of information would result in a piece of industrial equipment that is reasonably feasible to manufacture;
accepting the at least one item of information when the at least one item of information would result in a piece of industrial equipment that is reasonably feasible to manufacture; and
rejecting the at least one item of information when the at least one item of information would not result in a piece of industrial equipment that is reasonably feasible to manufacture.

24. The non-transitory computer-readable medium of claim 14, wherein the receiving step comprises:
checking at least one item of information received from the user to determine whether the at least one item of information would result in a piece of industrial equipment that is compatible with at least one other item of industrial equipment;
accepting the at least one item of information when the at least one item of information would result in a piece of industrial equipment that is compatible with the at least one other item of industrial equipment; and
rejecting the at least one item of information when the at least one item of information would not result in a piece of industrial equipment that is compatible with the at least one other item of industrial equipment.

25. The non-transitory computer-readable medium of claim 14, wherein the receiving step comprises receiving multiple items of information that define characteristics of a first piece of industrial equipment, and wherein the method performed by the one or more processors further comprises:
receiving from the user multiple items of information that define characteristics of a second piece of industrial equipment
checking at least one of the items of information received from the user for either the first or the second piece of equipment to determine whether the at least one item of information would result in the first and second pieces of industrial equipment being compatible with one another;
accepting the at least one item of information when the at least one item of information would result in the first and second pieces of industrial equipment being compatible with one another; and
rejecting the at least one item of information when the at least one item of information would not result in the first and second pieces of industrial equipment being compatible with one another.

26. The non-transitory computer-readable medium of claim 14, wherein when the result of the determining step indicates that multiple vendors offer a piece of industrial equipment having the characteristics defined by the items of information received from the user, the offering step comprises displaying information from each of the vendors that offer a piece of industrial equipment having the characteristics defined by the items of information received from the user.
